(19) United States
(12) Patent Application Publication
(10) Pub. No.: US 2013/0214496 A1
(43) Pub. Date: Aug. 22, 2013

(54) Chuck

(71) Applicant: Jack LIN, Taichung City (TW)

(72) Inventor: Jack LIN, Taichung City (TW)

(21) Appl. No.: 13/400,041

(22) Filed: Feb. 18, 2012

(51) Int. Cl. B23B 31/22

(52) U.S. Cl. 279/46.7

(57) ABSTRACT

A chuck includes a shaft, a ring, a ball and an elastic helical ferrule. The shaft includes a cavity defined therein and an aperture in communication with the cavity. The aperture includes a large open end and a small open end. The ring includes a tunnel for receiving the shaft. The ball includes a first portion for insertion in the tunnel via the large open end of the aperture and a second portion for insertion in the cavity via the small open end of the aperture. The elastic helical ferrule includes sections for contact with the ball and sections in contact with the shaft.

### BACKGROUND OF INVENTION

1. Field of Invention

The present invention relates to a tool and, more particularly, to a chuck for connecting a bit to a handle of a tool.

2. Related Prior Art

As disclosed in Taiwanese Patent M391448, a conventional chuck 60 includes a cylinder 61, two springs 62 and 65, two pushers 63 and 66 and two detents 64. The cylinder 61 includes three tunnels 611, 613 and 614 in communication with one another. The cylinder 61 is connected to a handle of a tool. The diameters of the tunnels 611 and 613 are constant. The diameter of the first tunnel 611 is smaller than that of the second tunnel 613. The third tunnel 614 is in the shape of a conical frustum so that its diameter gets larger as it extends from the second tunnel 613. The first spring 62 is placed in the second tunnel 613. The first pusher 63 which is in the form of a ring includes a first portion placed in the second tunnel 613 and a second portion placed in the third tunnel 614. The first spring 62 is compressed between a shoulder formed between the tunnels 611 and 613 and the first pusher 63. Each of the detents 64 is placed in a respective one of two apertures 632 defined in the second portion of the first pusher 63. The second spring 65 is placed around the cylinder 61. The second pusher 66 which is also in the form of a ring is placed around the second spring 65. The second spring 65 is compressed between a C-clip connected to an external side of the cylinder 61 and a C-ring attached to an internal side of the second pusher 66. With the springs 62 and 65 in operation against each other, each of detents 64 includes an internal portion normally placed in a tunnel 631defined in the first ring 63 and an external portion placed in the third tunnel 614 defined in the cylinder 61. To connect a bit to the handle, the second pusher 66 is pushed away from the handle against the second spring 65, thus allowing the first spring 62 to push the first portion of the first pusher 63 out of the second tunnel 613 of the cylinder 61 and the second portion of the first pusher 63 out of the third tunnel 614 of the cylinder 61. Hence, the internal portion of each of the detents 64 is movable out of the tunnel 631 of the first pusher 63 and a portion of the bit is allowed into the first pusher 63 and the cylinder 61. Then, the second pusher 66 is released so that the internal portion of each of the detents 64 is moved into the tunnel 631 of the first pusher 63 and abutted against the bit so that the portion of the bit is retained in the first pusher 63 and the cylinder 61. However, the second pusher 66 might be pushed excessively far away from the handle, thus allowing the detents 64 to be moved out of the apertures 632 of the first pusher 63 and caught between a portion of the cylinder 61 and a portion of the second pusher 66. Hence, the returning of the second pusher 66 is hindered, and so is the connection of the bit to the handle.

The present invention is therefore intended to obviate or at least alleviate the problems encountered in prior art.

### SUMMARY OF INVENTION

It is the primary objective of the present invention to provide a reliable chuck.

To achieve the foregoing objectives, the chuck includes a shaft, a ring, a ball and an elastic helical ferrule. The shaft includes a cavity defined therein and an aperture in communication with the cavity. The aperture includes a large open end and a small open end. The ring includes a tunnel for receiving the shaft. The ball includes a first portion for insertion in the tunnel via the large open end of the aperture and a second portion for insertion in the cavity via the small open end of the aperture. The elastic helical ferrule includes sections for contact with the ball and sections in contact with the shaft. Other objectives, advantages and features of the present invention will be apparent from the following description referring to the attached drawings.

### BRIEF DESCRIPTION OF DRAWINGS

The present invention will be described via detailed illustration of four embodiments referring to the drawings wherein:

FIG. 1 is a cross-sectional view of a chuck according to the first embodiment of the present invention;

FIG. 2 is an enlarged, partial, cross-sectional view of the chuck shown in FIG. 1;

FIG. 3 is an enlarged, partial, cross-sectional view of the chuck shown in FIG. 2;

FIG. 4 is a side view of a bit connected to the chuck shown in FIG. 1;

FIG. 5 is a cross-sectional view of a chuck according to the second embodiment of the present invention;

FIG. 6 is a side view of several bits that can be connected to the chuck shown in FIG. 5;

FIG. 7 is an enlarged, side view of an exemplary one of the bits in a position during the connection to the chuck shown in FIG. 6;

FIG. 8 is an enlarged, side view of the exemplary bit in another position than shown in FIG. 7;

FIG. 9 is a cross-sectional view of a chuck according to the third embodiment of the present invention;

FIG. 10 is a side view of a bit in a position during the connection to the chuck shown in FIG. 9;

FIG. 11 is a side view of the bit in another position than shown in FIG. 10;

FIG. 12 is a cross-sectional view of a chuck according to the fourth embodiment of the present invention;

FIG. 13 is a side view of a bit in a position during the connection to the chuck shown in FIG. 12; and

FIG. 14 is a side view of the bit in another position than shown in FIG. 13.

### DETAILED DESCRIPTION OF EMBODIMENTS

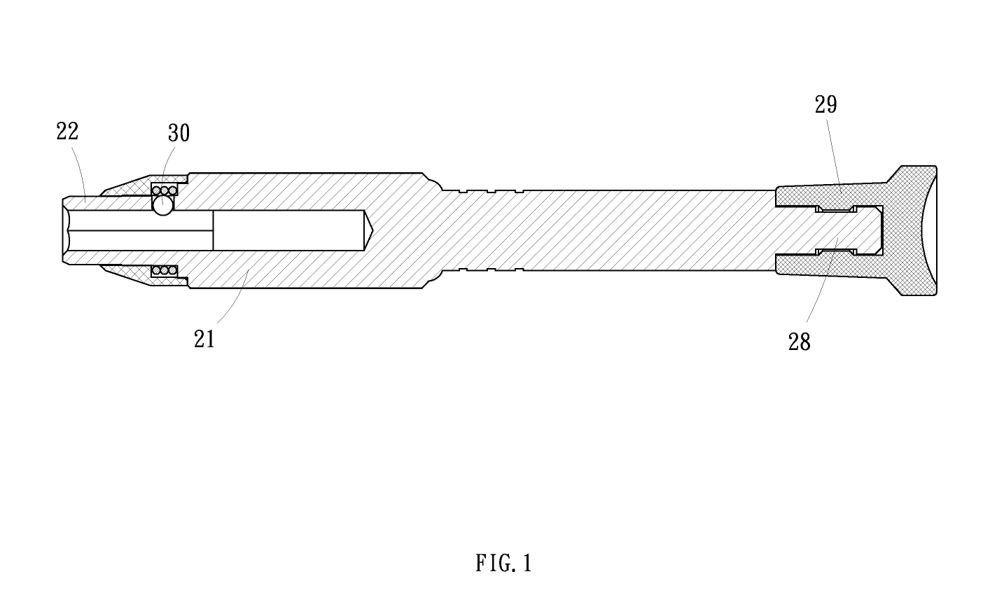

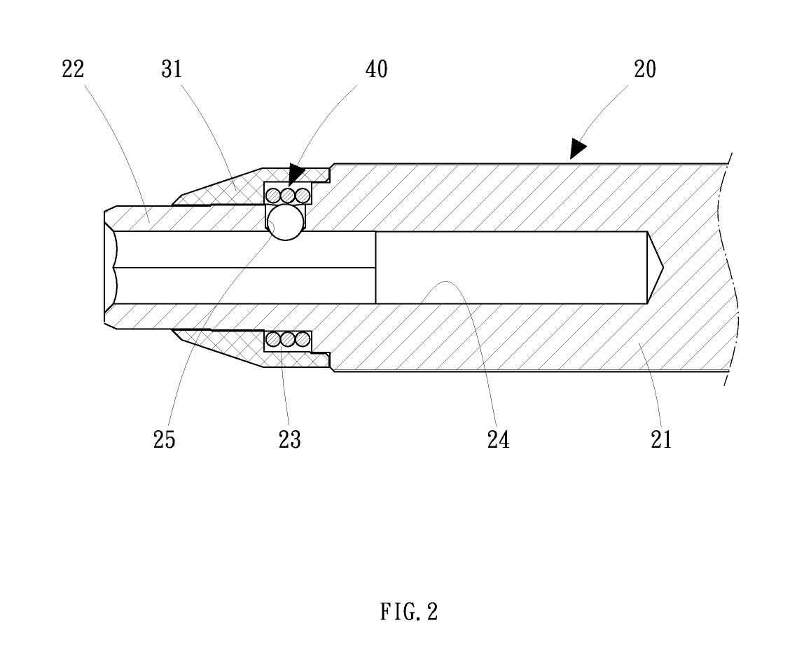

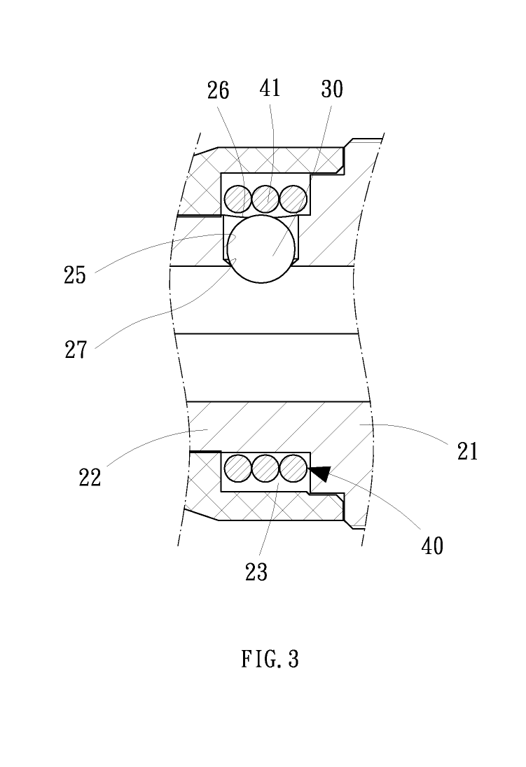

Shown in FIGS. 1 to 4 is a chuck 20 according to a first embodiment of the present invention. The chuck 20 includes a shaft 21, a cap 29, a ball 30, a ring 31 and an elastic helical ferrule 40.

The shaft 21 includes a stepped end 22 and a recessed end 28. The stepped end 22 of the shaft 21 includes a thick section and a thin section.

By molding for example, the cap 29 is formed around the recessed end 28 of the shaft 21 so that the recessed end 28 of the shaft 21 is firmly placed in the cap 29.

The shaft 21 includes a cavity 24 axially defined therein. The cavity 24 includes a circular section and a hexagonal section. The thin section of the stepped end 22 of the shaft 21 includes an aperture 25 in communication with the hexagonal section of the cavity 24. The aperture 25 includes a large open end 26 and a small open end 27 in communication with the hexagonal section of the cavity 24.

The diameter of the ball 30 is larger than that of the small open end 27 of the aperture 25 but shorter than that of the large open end 26 of the aperture 25. Thus, the ball 30 can be placed in the aperture 25 via the large open end 26 but cannot be placed entirely in the hexagonal section of the cavity 24 from the aperture 25 via the small open end 27.

The elastic helical ferrule 40 includes several sections each extending for 360°. The elastic helical ferrule 40 is placed around the thin section of the stepped end 22 of the shaft 21 after the ball 30 is placed in the aperture 25. The ball 30 includes a first portion in contact with the elastic helical ferrule 40 and a second portion placed in the hexagonal section of the cavity 24 via the small open end 27 of the aperture 25.

The ring 31 includes a stepped tunnel 23 axially defined therein. The stepped tunnel 23 includes a large section and a small section regarding the diameter. The thick section of the stepped end 22 of the shaft 21 is fit in the large section of the stepped tunnel 23 of the ring 31 while the thin section of the stepped end 22 of the shaft 21 is inserted in the small section of the stepped tunnel 23. The elastic helical ferrule 40 is placed in the large section of the stepped tunnel 23.

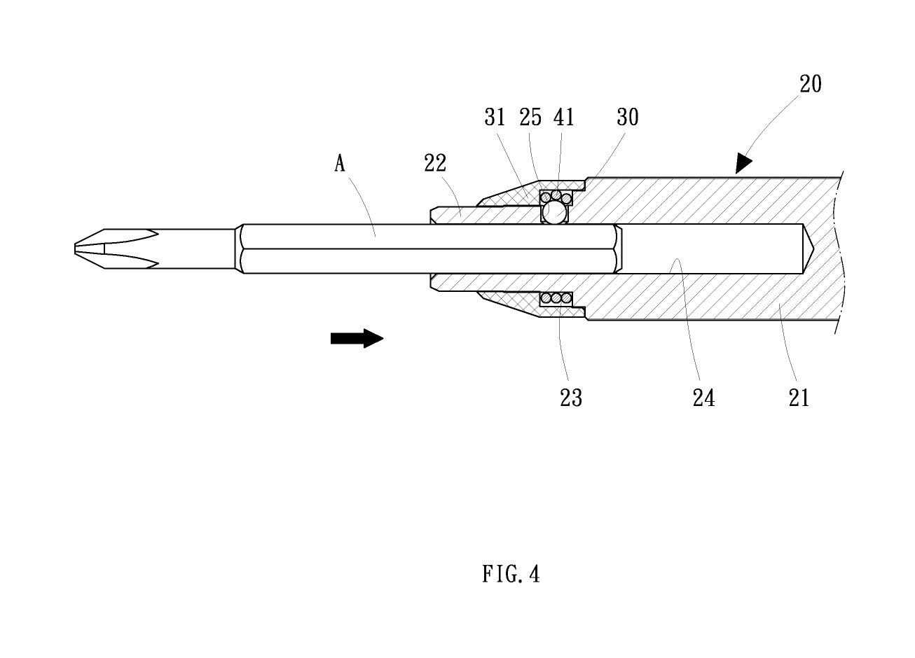

Referring to FIG. 4, a bit A is partially inserted in the hexagonal section of the cavity 24 by force. The ball 30 is pushed out of the hexagonal section of the cavity 24 by the bit A so that the bit A can be inserted further in the hexagonal section of the cavity 24. The first portion of the ball 30 is biased by the elastic helical ferrule 40 so that the second portion of the ball 30 is abutted against the bit A. Hence, the bit A is kept partially in the hexagonal section of the cavity 24.

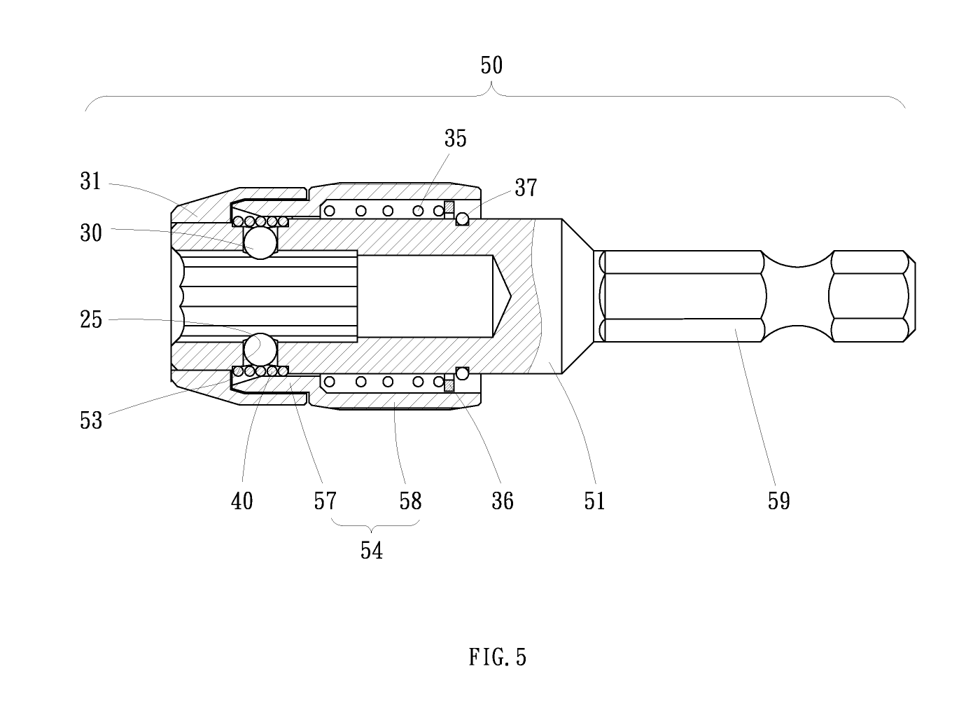

Shown in FIG. 5 is a chuck 50 according to a second embodiment of the present invention. The second embodiment is like the first embodiment except several things. At first, a shaft 51 is used instead of the shaft 21. The shaft 51 is like the shaft 21 excepting saving the stepped end 22 and including a recessed hexagonal end 59 instead of the recessed end 28, two apertures 25 instead of one, and a groove 53 in communication with the apertures 25. The elastic helical ferrule 40 is placed in the groove 53.

Secondly, two balls 30 are used instead of one. Accordingly, the shaft 51 includes two apertures 25 each for receiving a respective ball 30.

Thirdly, a spring 35 and a ring 54 are used additionally. The ring 54 includes a thin section 57 and a thick section 58. A conical frustum-shaped face is formed on an internal side of the thin section 57 of the ring 54. The ring 54 is provided around and movable along the shaft 51. The thin section 57 of the ring 54 is placed in the large section of the stepped tunnel 23 of the ring 31.

The spring 35 is placed around the shaft 51 and in the thick section 58 of the ring 54. A C-clip 37 is fit around the shaft 51. A C-ring 36 is placed against the C-clip 37. The spring 35 is compressed between the C-ring 36 and an internal shoulder of the ring 54 formed between the sections 57 and 58.

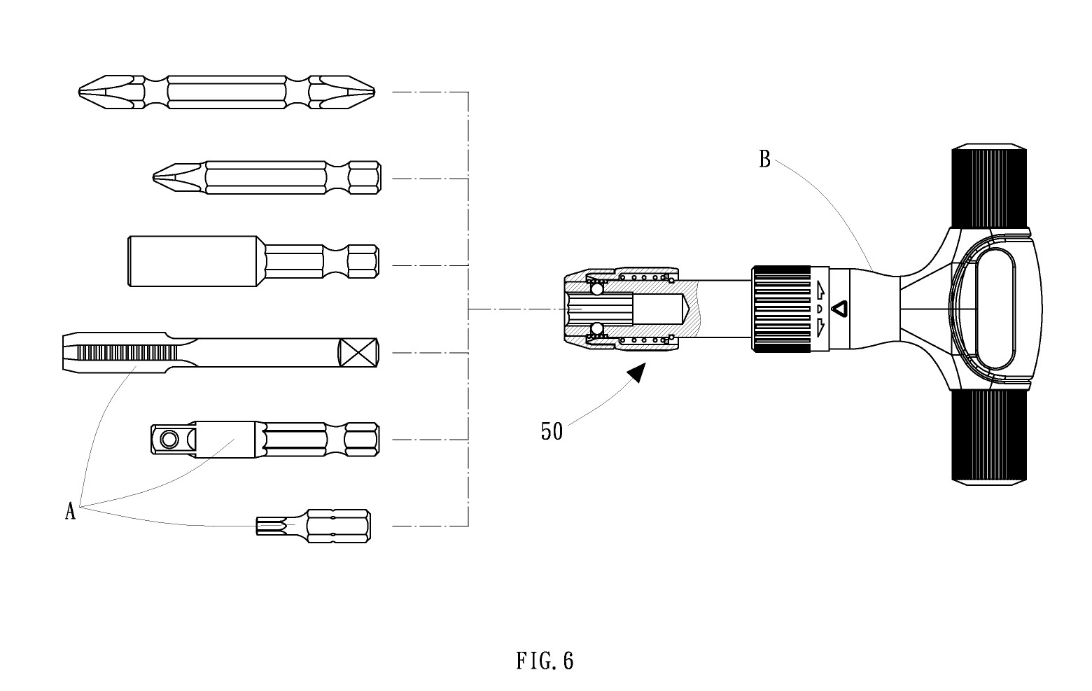

Shown in FIG. 6 are several bits A that can be connected to a handle B via the chuckle shown in FIG. 5. The recessed hexagonal end 59 of the shaft 51 is fit in the handle B.

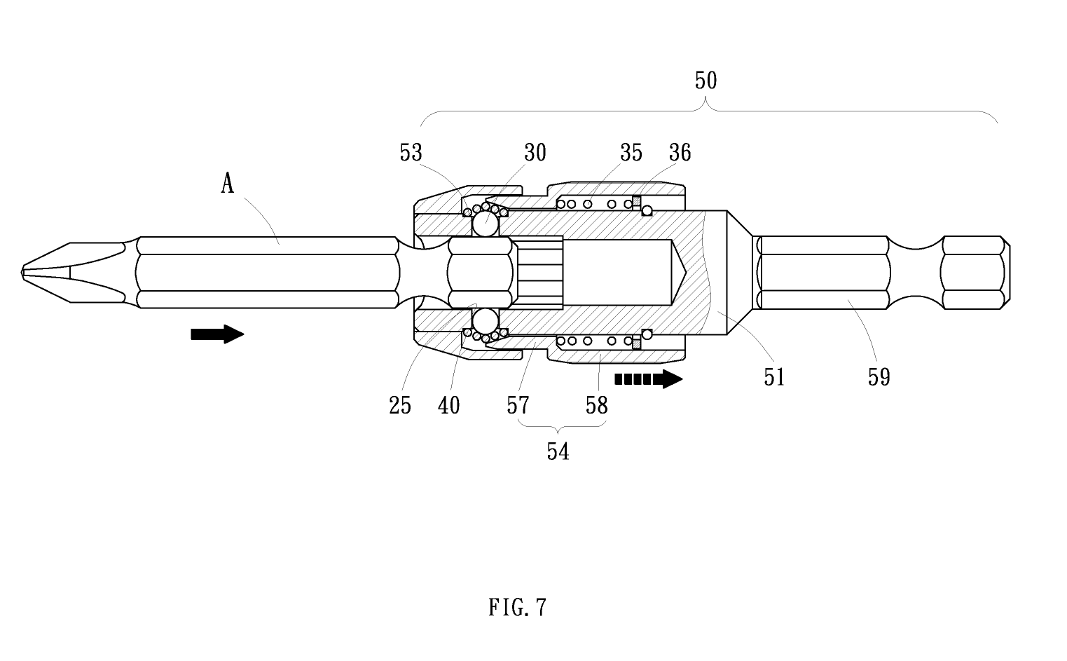

Referring to FIG. 7, to insert a bit A partially in the hexagonal section of the cavity 24, the ring 54 is moved away from the ring 31 so that the conical frustum-shaped face of the thin section 57 of the ring 54 is aligned with the first portion of each ball 30. Thus, some of the sections 41 of the elastic helical ferrule 40 and the first portion of each ball 30 can be moved into the large section of the stepped tunnel 23 of the ring 31. Hence, the second portion of each ball 30 is movable out of the hexagonal section of the cavity 24, and the portion of the bit A can be inserted further into the hexagonal section of the cavity 24.

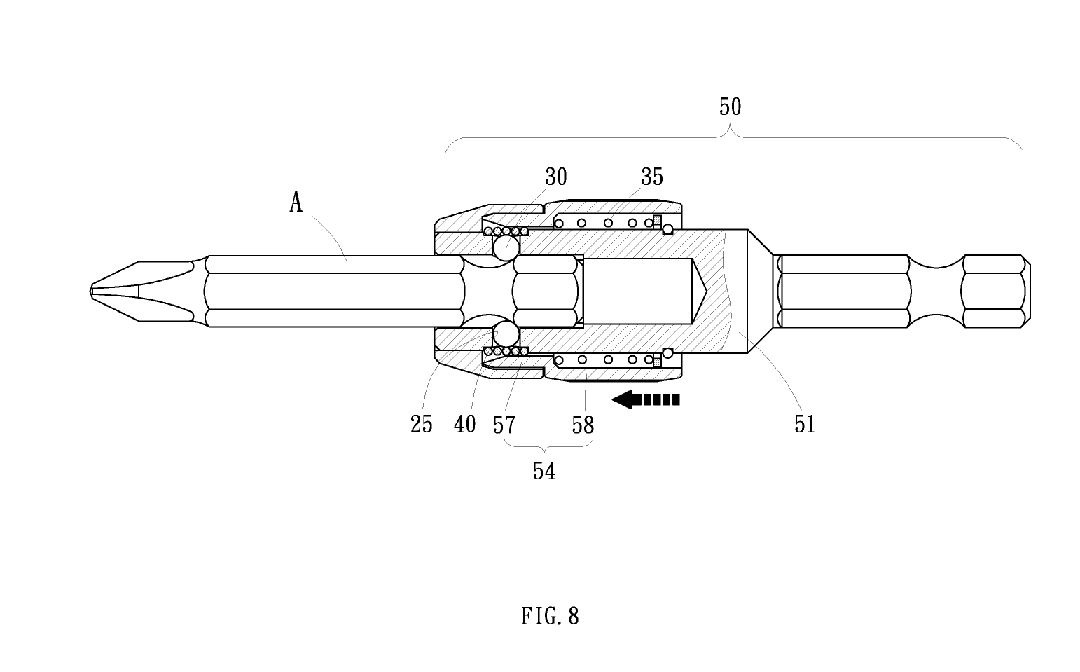

Referring to FIG. 8, the ring 54 is released. The spring 35 returns the ring 54. Thus, most of the sections 41 of the elastic helical ferrule 40 are pressed by the internal side of the thin section 57 of the ring 54. The first portion of each ball 30 is moved in the respective aperture 25 while the second portion of each ball 30 is placed in the hexagonal section of the cavity 24 and against a neck of the bit A. Hence, the bit A is retained partially in the hexagonal section of the cavity 24.

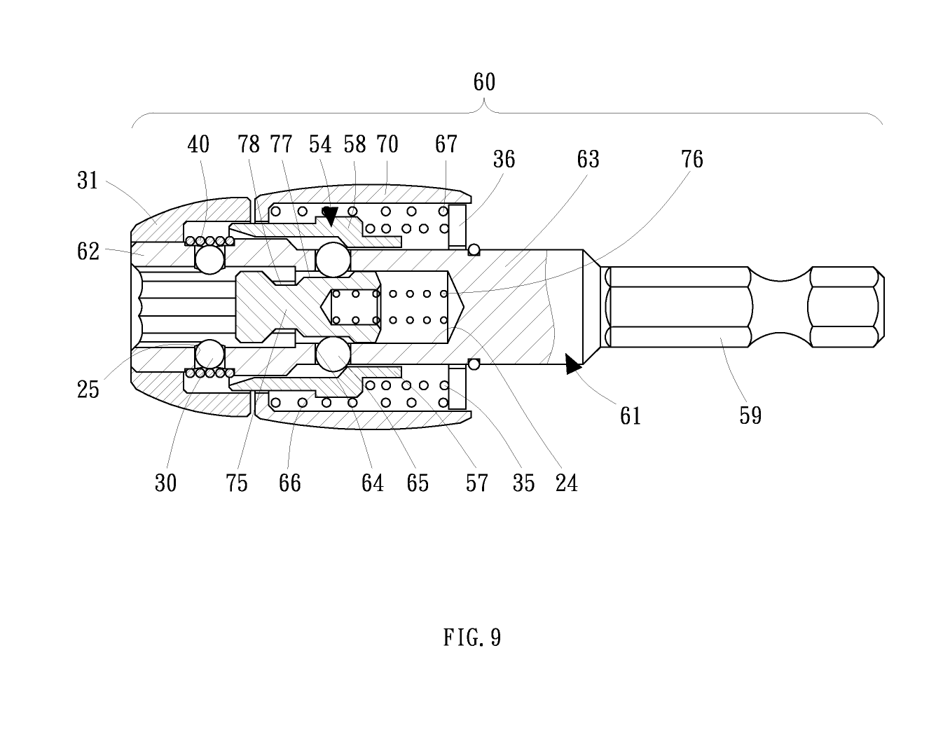

Shown in FIG. 9 is a chuck 60 according to a third embodiment of the present invention. The third embodiment is like the second embodiment except several things. At first, a spring 76 is used to bias a pusher 75 to push the bit A. The pusher 75 is formed with a first reduced section 77 and a second reduced section 78 of a diameter smaller than that of the first reduced section 77. The pusher 75 is movably placed in the cavity 24.

Secondly, the ring 54 is directed oppositely. The ring 54 is formed with a first external shoulder between the sections 57 and 58 and a second external shoulder 66 on the thick section 58. The spring 35 is compressed between the C-ring 36 and the first external shoulder of the ring 54.

Thirdly, a shaft 61 is used instead of the shaft 51. The shaft 61 is like the shaft 51 except including two apertures 64 defined in a thin hollow section 63 formed between a thick hollow section 62 and the recessed hexagonal end 59.

Fourthly, there are used two balls 65 each ball 65 is placed in a respective aperture 64 and formed with a first portion for contact with the internal shoulder of the ring 54 and a second portion in contact with the pusher 75.

Fifthly, a ring 70 is provided around the ring 54. The ring 70 includes an internal flange formed at an end.

Sixthly, a spring 67 is placed around the ring 54 and in the ring 70. The spring 67 is compressed between the C-ring 36 and the internal flange of the ring 70.

The first portion of each ball 65 is in contact with the internal shoulder of the ring 54 while the second portion of the same is in contact with the first reduced section 77 of the pusher 75. Thus, the balls 65 prevent the ring 54 from pressing the elastic helical ferrule 40. Hence, the first portion of each ball 30 is movable out of the respective aperture 25 against the elastic helical ferrule 40 while the second portion of each ball 30 is movable out of the hexagonal section of the cavity 24.

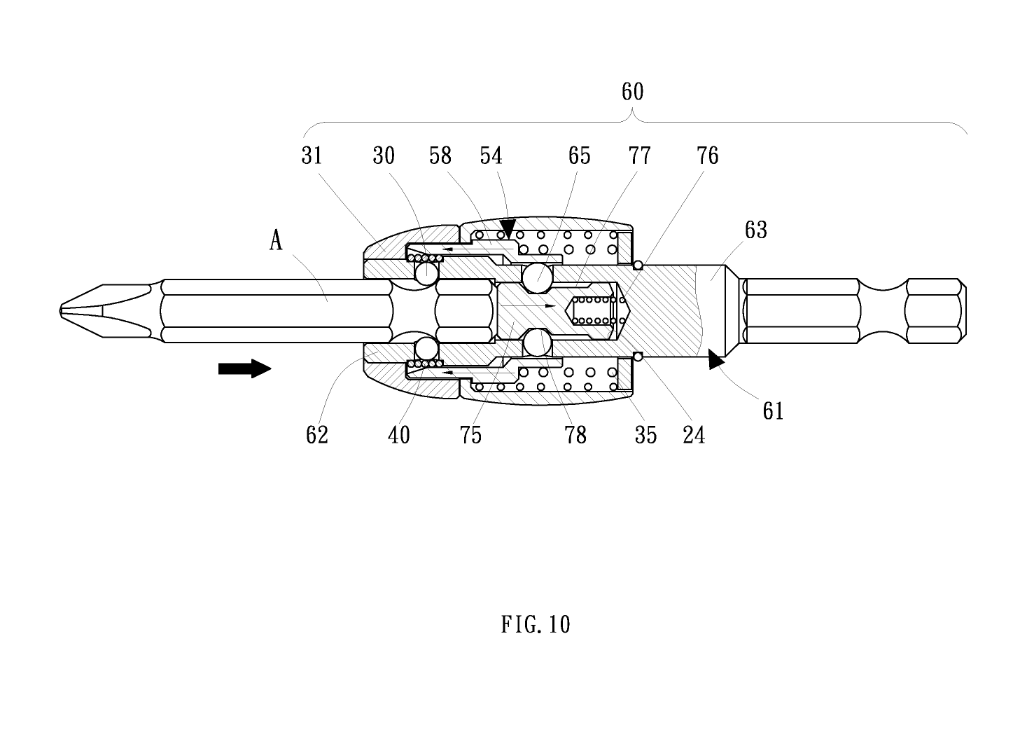

Referring to FIG. 10, the bit A is inserted in the hexagonal section of the cavity 24 to place the pusher 75 entirely in the circular section of the cavity 24 against the spring 76. As the second portion of each ball 65 is allowed to fall onto the second reduced section 78 of the pusher 75, the spring 35 pushes the ring 54 over the balls 65. Thus, the thick section 58 of the ring 54 restrains the elastic helical ferrule 40 while the thin section 57 of the same restrains the balls 65. Hence, the elastic helical ferrule 40 keeps the first portion of each ball 30 in the respective aperture 25 and the second portion of the same in the hexagonal section of the cavity 24 and against the neck of the bit A. Moreover, the second portion of each ball 65 is kept against the second reduced section 78 of the pusher 75, thus restraining the pusher 75.

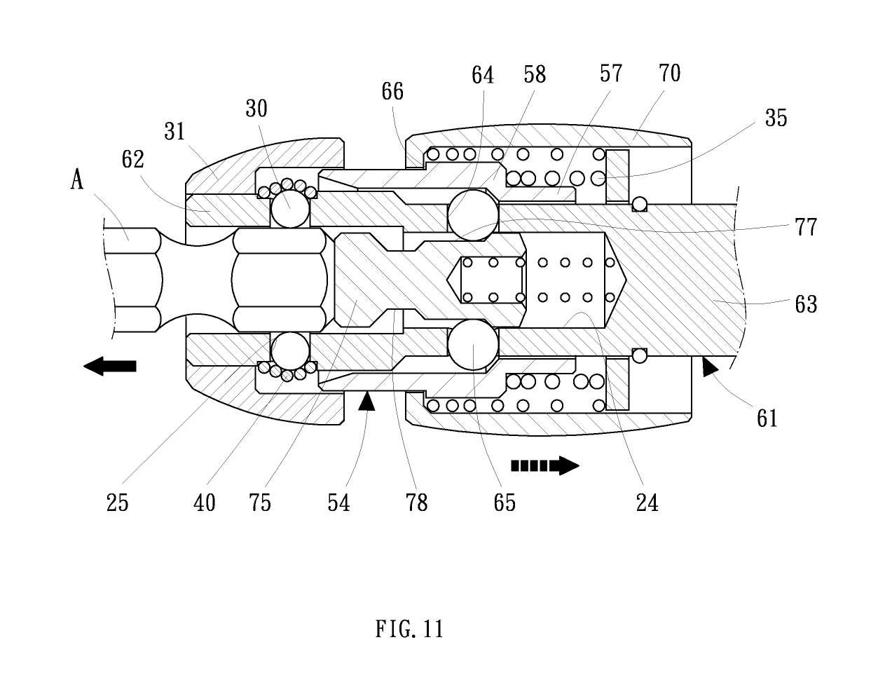

Referring to FIG. 11, the ring 70 is pushed to move the ring 54 as the internal flange of the former is placed against the second external shoulder 66 of the latter. The first portion of each ball 65 is allowed to enter a space in the thick section 58 of the ring 54 while the first portion of each ball 30 is allowed to enter the large section of the stepped tunnel 23 of the ring 31. Therefore, the spring 76 biases the pusher 75 against the second portion of each ball 65, and the pusher 75 pushes the bit A against the second portion of each ball 30.

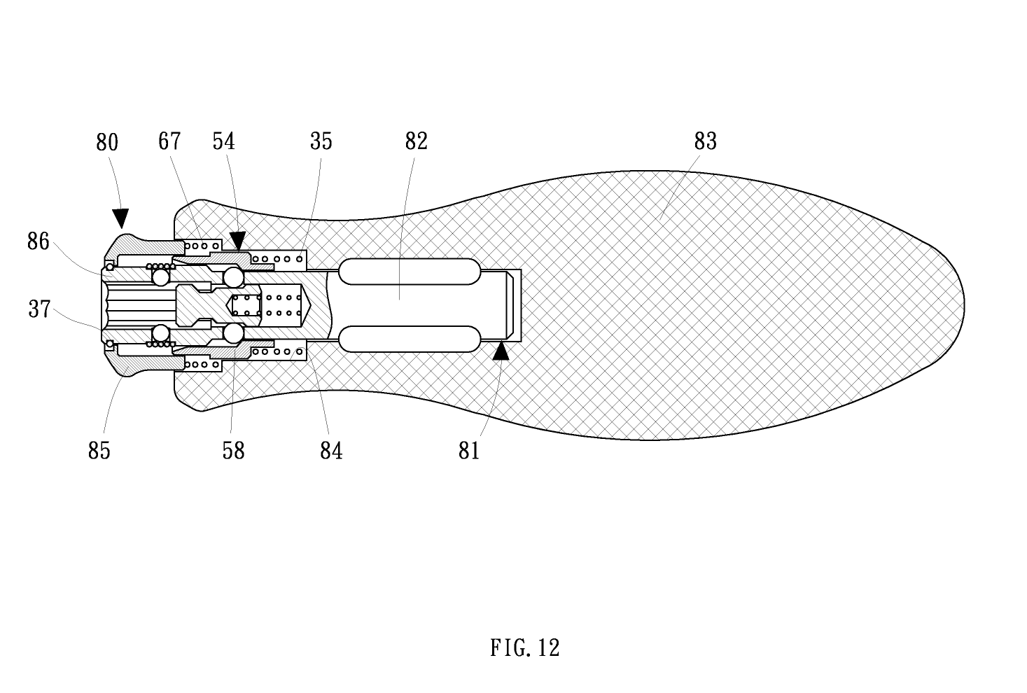

Shown in FIG. 12 is a chuck 80 according to a fourth embodiment of the present invention. The fourth embodiment is like the third embodiment except several things. At first, the ring 70 is saved.

Secondly, there is used a handle 83. The handle 83 includes a stepped cavity 84 defined therein. The handle 83 includes two internal shoulders formed on the wall of the stepped cavity 84. The spring 35 is compressed between the first internal shoulder of the handle 83 and the first external shoulder of the ring 54.

Thirdly, a shaft 81 is used instead of the shaft 61. The shaft 81 is like the shaft 61 except including a ribbed end 82 stead of the recessed hexagonal end 59. The ribbed end 82 of the shaft 81 is fit in the stepped cavity 84 of the handle 83.

Fourthly, a ring 85 is used instead of the ring 31. The ring 85 is placed around and movable along the shaft 81. Accordingly, the C-clip 37 is placed in another position for contact with an annular flange formed at a first end of the ring 85. The spring 67 is compressed between the second internal shoulder of the handle 83 and a second end of the ring 85.

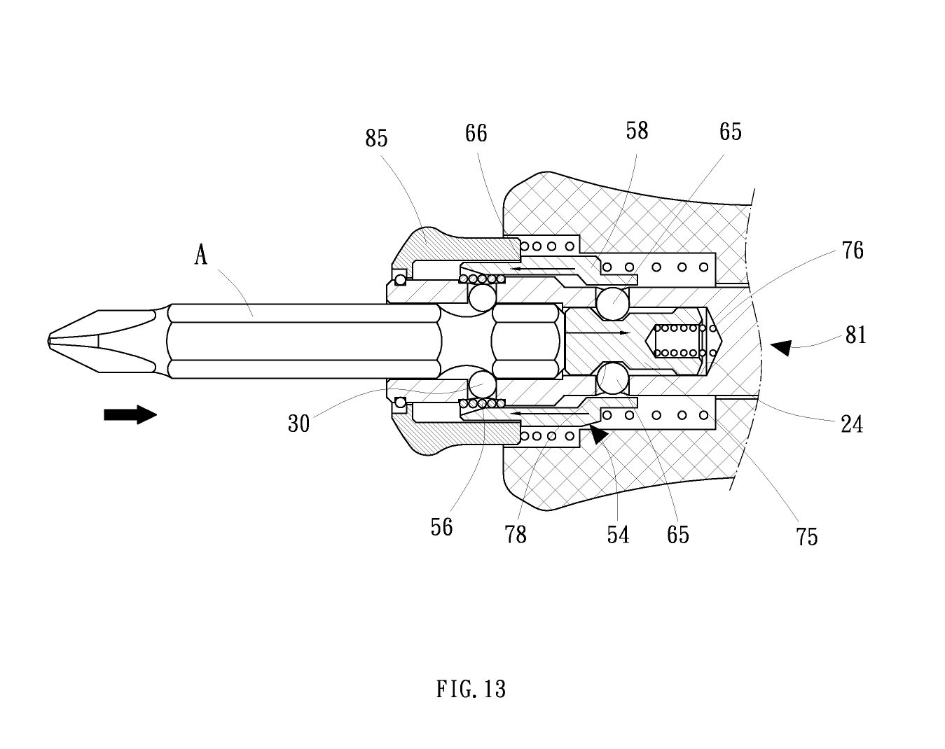

Referring to FIG. 13, the bit A is inserted in the hexagonal section of the cavity 24 to place the pusher 75 entirely in the circular section of the cavity 24 against the spring 76. As the second portion of each ball 65 is allowed to fall onto the second reduced section 78 of the pusher 75, the spring 35 pushes the ring 54 over the balls 65. Thus, the thick section 58 of the ring 54 restrains the elastic helical ferrule 40 while the thin section 57 of the same restrains the balls 65. Hence, the elastic helical ferrule 40 keeps the first portion of each ball 30 in the respective aperture 25 and the second portion of the same in the hexagonal section of the cavity 24 and against the neck of the bit A. Moreover, the second portion of each ball 65 is kept against the second reduced section 78 of the pusher 75, thus restraining the pusher 75.

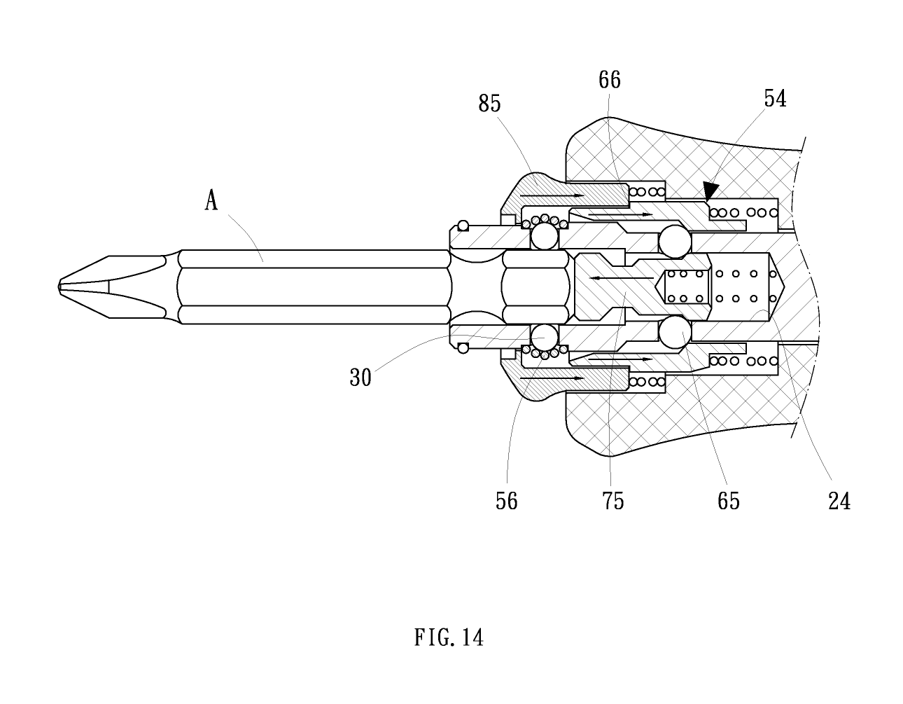

Referring to FIG. 14, the ring 85 is pushed to move the ring 54 as the second end of the former is placed against the second external shoulder of the latter. The first portion of each ball 65 is allowed in the space defined in the thick section 58 of the ring 54, and the first portion of each ball 30 is allowed in the large section of the stepped tunnel 23. Hence, the spring 76 biases the pusher 75 against the second portion of each ball 65, and the pusher 75 pushes the bit A against the second portion of each ball 30.

The present invention has been described via the detailed illustration of the embodiments. Those skilled in the art can derive variation ns from the embodiments without departing from the scope of the present invention. Therefore, the embodiments shall not limit the scope of the present invention defined in the claims.

1. A chuck including:
a shaft including a cavity defined therein and a first aperture in communication with the cavity, wherein the first aperture includes a large open end and a small open end;
a stationary ring including a tunnel for receiving the shaft;
a first ball substantially placed in the first aperture and formed with a first portion for insertion in the tunnel via the large open end of the first aperture and a second portion for insertion in the cavity via the small open end of the first aperture; and
an elastic helical ferrule including sections for contact with the first portion of the ball and sections in contact with the shaft.

2. The chuck according to claim 1, further including:
a movable ring placed around and movable along the shaft between the first and second positions;
a clip fit around the shaft; and
a spring compressed between the movable ring and the clip for biasing the movable ring to the first position.

3. The chuck according to claim 1, wherein the shaft further includes a second aperture in communication with the cavity, wherein the chuck further includes:
a movable ring placed around and movable along the shaft between the first and second positions;
a clip fit around the shaft;
a first spring compressed between the movable ring and the clip for biasing the movable ring to the first position;
a pusher formed with a first reduced section and a second reduced section of a diameter smaller than that of the first reduced section, and movably inserted in the cavity for pushing a bit A;
a second spring compressed between the pusher and a closed end of the cavity;
a second ball formed with first and second portions and placed in the aperture, wherein the first portion of the second ball abuts and keeps the movable ring in the second position as the second portion of the second ball contacts the first reduced section of the pusher when the pusher is not pushed by the bit A, wherein the first portion of the second ball releases and allows the movable ring to the first position as the second portion of the second ball contacts the second reduced section of the pusher when the pusher is pushed by the bit A.

4. The chuck according to claim 3, wherein the restraining device includes an operative ring placed around the shaft and operable for moving the movable ring to the second position from the first position.

5. The chuck according to claim 4, wherein the operative ring is movable between a first position and a second position, wherein the movable ring is in contact with the operative ring as the movable ring is in the first position and the operative ring is in the first position.

6. The chuck according to claim 5, wherein restraining device further includes a third spring compressed between the operative ring and the clip for biasing the operative ring to the first position.

7. A chuck including:
a shaft including a cavity defined therein, a first aperture in communication with the cavity, and a second aperture in communication with the cavity, wherein the aperture includes a large open end and a small open end;
a handle connected to the shaft;
a first ball substantially placed in the aperture and formed with a first portion for extending out of the large open end of the aperture and a second portion for insertion in the cavity via the small open end of the aperture;
an elastic helical ferrule including sections for contact with the first portion of the first ball and sections in contact with the shaft; and
a movable ring placed around and movable along the shaft between the first and second positions;
a first spring compressed between the movable ring and the handle for biasing the movable ring to the first position;
a pusher formed with a first reduced section and a second reduced section of a diameter smaller than that of the first reduced section, and movably inserted in the cavity for pushing a bit A;
a second spring compressed between the pusher and a closed end of the cavity;
a second ball formed with first and second portions and placed in the second aperture, wherein the first portion of the second ball abuts and keeps the movable ring in the second position as the second portion of the second ball contacts the first reduced section of the pusher when the pusher is not pushed by the bit A, wherein the first portion of the second ball releases and allows the movable ring to the first position as the second portion of the second ball contacts the second reduced section of the pusher when the pusher is pushed by the bit A; and
an operative ring placed around the shaft and operable for moving the movable ring to the second position from the first position.

8. The chuck according to claim 7, wherein the operative ring is movable between a first position and a second position, wherein the movable ring is in contact with the operative ring when the movable ring is in the first position and the operative ring is in the first position.

9. The chuck according to claim 8, further including a third spring compressed between the operative ring and the handle for biasing the operative ring to the first position.
